(19) United States
(12) Patent Application Publication
(10) Pub. No.: US 2026/0195974 A1
(43) Pub. Date: Jul. 9, 2026

(54) GENERATION OF THREE-DIMENSIONAL AVATAR

(71) Applicant: Microsoft Technology Licensing, LLC, Redmond, WA (US)

(72) Inventors: Dong CHEN, Redmond, WA (US); Bo ZHANG, Redmond, WA (US); Ting ZHANG, Redmond, WA (US); Shuyang GU, Redmond, WA (US); Jianmin BAO, Redmond, WA (US); Tadas BALTRUSAITIS, Redmond, WA (US); Jingjing SHEN, Redmond, WA (US); Fang WEN, Redmond, WA (US); Baining GUO, Redmond, WA (US); Tengfei WANG, Redmond, WA (US)

(73) Assignee: Microsoft Technology Licensing, LLC, Redmond, WA (US)

(21) Appl. No.: 19/132,536

(22) PCT Filed: Nov. 23, 2023
(86) PCT No.: PCT/US2023/081025

§ 371 Date: May 23, 2025

(30) Foreign Application Priority Data
Dec. 12, 2022 (CN) 202211600403.0

(51) Int. Cl. G06T 15/20; G06T 3/40; G06V 10/40

(52) U.S. Cl. CPC G06T 15/20; G06T 3/40; G06V 10/40; G06T 2210/36

(57) ABSTRACT

According to implementations of the subject matter described herein, a solution for generation of three-dimensional avatar is provided. According to this solution, a trained diffusion model is obtained, which is trained based on a sample three-dimensional avatar of a sample object. A target feature representation is generated from a predetermined input using the diffusion model. The target feature representation comprises a set of target feature maps corresponding to a tri-plane, respectively, to characterize feature information of a target object in a three-dimensional space. A three-dimensional avatar of the target object is generated based on the target feature representation. In this way, high-quality three-dimensional avatars can be generated in an efficient way, with reduced memory and computing costs.

### BACKGROUND

It is expected to generate and utilize diversified three-dimensional (3D) avatars in various application scenarios, including people's daily social interactions, games, videos, and various 3D industries. 3D avatar, also known as 3D digital avatar, refers to a three-dimensional body that can vividly reflect visual characteristics of an object. In conventional solutions, artists usually painstakingly create and portray 3D avatars. This is not only laborious, but also makes it difficult to create a large scale of diversified 3D avatars. With the development of machine learning-based computer vision techniques, automatic generation of 3D data based on generative model is a very promising work.

### SUMMARY

According to implementations of the subject matter described herein, a solution for generation of three-dimensional avatar is proposed. In this solution, a trained diffusion model is obtained, which is trained based on a sample three-dimensional avatar of a sample object. A target feature representation is generated from a predetermined input using the diffusion model. The target feature representation comprises a set of target feature maps corresponding to a tri-plane, respectively, to characterize feature information of a target object in a three-dimensional space. A three-dimensional avatar of the target object is generated based on the target feature representation. In this way, high-quality three-dimensional avatars can be generated in an efficient way, with reduced memory and computing costs.

The Summary is provided to introduce a selection of concepts in a simplified form that are further described below in the Detailed Description. The Summary is neither intended to identify key features or essential features of the subject matter described herein, nor is it intended to be used to limit the scope of the subject matter described herein.

### BRIEF DESCRIPTION OF THE DRAWINGS

FIG. 1 illustrates a block diagram of an example environment in which various implementations of the subject matter described herein can be implemented;

FIG. 2 illustrates a schematic block diagram of a system for 3D avatar generation in accordance with some implementations of the subject matter described herein;

FIG. 3 illustrates a schematic block diagram of a diffusion model in accordance with some implementations of the subject matter described herein;

FIGS. 4A and 4B illustrate examples of tri-plane feature representation in accordance with some implementations of the subject matter described herein;

FIG. 5 illustrates a schematic block diagram of an example model structure for generating constraint information in accordance with some implementations of the subject matter described herein;

FIG. 6 illustrates a schematic block diagram of the structure of a decoder model in accordance with some implementations of the subject matter described herein;

FIG. 7 illustrates a flowchart of a process for generating a 3D avatar in accordance with some implementations of the subject matter described herein; and

FIG. 8 illustrates a schematic block diagram of an electronic device in which various implementations of the subject matter described herein can be implemented.

Throughout the drawings, the same or similar reference symbols refer to the same or similar elements.

### DETAILED DESCRIPTION OF EMBODIMENTS

The subject matter described herein will now be described with reference to some example implementations. It is to be understood that these implementations are described only for the purpose of illustration and help those skilled in the art to better understand and thus implement the subject matter described herein, without suggesting any limitations to the scope of the subject matter described herein.

As used herein, the term “includes” and its variants are to be read as open terms that mean “includes but is not limited to.” The term “based on” is to be read as “based at least in part on.” The terms “an implementation” and “one implementation” are to be read as “at least one implementation.” The term “another implementation” is to be read as “at least one other implementation.” The term “first,” “second,” and the like may refer to different or the same objects. Other definitions, either explicit or implicit, may be included below.

As used herein, the term “model” may learn an association between corresponding input and output from training data, and thus a corresponding output may be generated for a given input after the training. The generation of the model may be based on machine learning techniques. Deep learning (DL) is one of machine learning algorithms that processes the input and provides the corresponding output using a plurality of layers of processing units. A neural network model is an example of a deep learning-based model. As used herein, “model” may also be referred to as “machine learning model”, “learning model”, “machine learning network” or “learning network”, which are used interchangeably herein.

Generally, machine learning may roughly include three stages, i.e., a training stage, a test stage, and an application stage (also referred to as an interference stage). In the training stage, a given model may be trained using a large scale of training data, with parameter values being iteratively updated until the model can obtain, from the training data, consistent interference that meets an expected target. Through the training, the model may be considered as being capable of learning the association between the input and the output (also referred to as an input-to-output mapping) from the training data. The parameter values of the trained model are determined. In the test stage, test inputs are applied to the trained model to test whether the model can provide correct outputs, so as to determine the performance of the model. In the interference stage, the model may be utilized to process an actual input based on the parameter values obtained from the training and to determine the corresponding output.

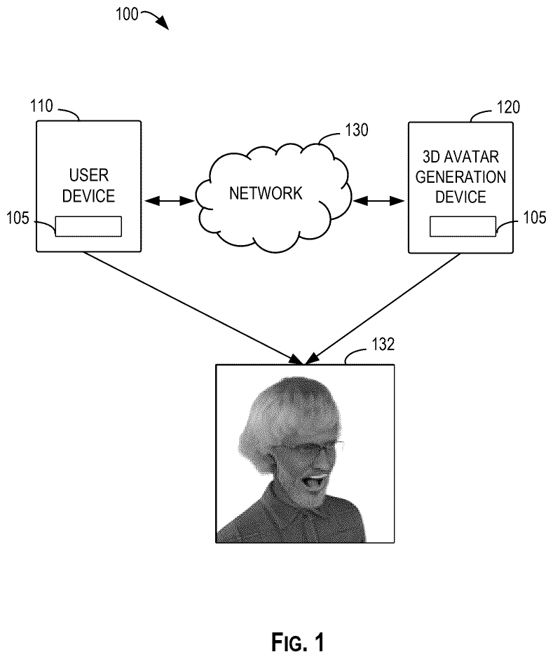

FIG. 1 illustrates a block diagram of an example environment 100 in which various implementations of the subject matter described herein can be implemented. In the environment of FIG. 1, a system 105 is configured to generate 3D avatars. The system 105 may be implemented on a user device 110 and/or a remote 3D avatar generation device 120. 3D avatar, also known as 3D digital avatar, refers to a 3D body or 3D model that can vividly reflect visual characteristics of an object. Objects that can be three-dimensional modelled by the system 105 may include people (for example, human head, half body, or full body avatar), animals, plants or other static and dynamic objects, and may even include composite objects or scenes, and the like. In FIG. 1, an example 3D avatar 132 generated by the system 105 is illustrated as an example of human avatar.

In some implementations, the system 105 may generate a 3D avatar based on a user request from the user device 110. In some implementations, if the system 105 is executed on the remote 3D avatar generation device 120 instead of locally to the user device 110, the user request can be sent to the 3D avatar generation device 120 via a network 130. The generated 3D avatar 132 may be sent back to the user device 110 via the network 130. In some implementations, the 3D avatar generation device 120 may generate a 3D avatar based on other trigger events. In some implementations, the 3D avatar generation device 120 may provide the 3D avatar generation service in response to requests from a plurality of user devices.

The user device 110 may include any type of mobile terminal, fixed terminal, or portable terminal, including mobile phone, desktop computer, laptop computer, netbook computer, tablet computer, media computer, multimedia tablet, or any combination thereof, including accessories and peripherals of these devices or any combination thereof. The server includes but is not limited to mainframes, edge computing nodes, computing devices in cloud environment, and the like. The 3D avatar generation device 120 may be any electronic device with computing capabilities, including servers, blade servers, mainframes, edge devices, and any other suitable computing devices.

It should be understood that the components and arrangements in the environment 100 shown in FIG. 1 are only examples, and computing systems suitable for implementing the example implementations of the subject matter described herein may include one or more different components, other components, and/or different arrangements.

With the rapid development of machine learning techniques, it is expected to automatically generate 3D avatars by generative models. Some solutions rely on either generation antagonism network (GAN) or variational autoencoder network (VAE) to model the distribution of 3D shape representation such as voxel grids, point clouds, mesh, and some implicit neural representations. However, such solutions cannot produce complex 3D avatars. In addition, the 3D shape representations (such as voxels, point clouds, and the like) generated in those solutions require a large amount of data for storage and processing, and thus the resource cost in both model training and model application phases is prohibitive. Other solutions use rich two-dimensional (2D) data to fit the three-dimensional radiance fields with image level distribution matching. However, the models obtained by those solutions suffer from instabilities and model collapse, and cannot generate authentic and high-quality 3D avatars.

In example implementations of the subject matter described herein, an improved solution for 3D avatar generation is proposed. This solution trains a diffusion model as a generative model to facilitate generation of a three-dimensional avatar of a target object. The diffusion model learns 3D knowledge from 3D avatars of sample objects. In addition, a 3D avatar is represented as a feature representation in a tri-plane form. Specifically, the diffusion model is configured to generate a target feature representation from a predetermined input. The target feature representation includes a set of target feature maps corresponding to a tri-plane to characterize feature information of the target object in a three-dimensional space. Compared with 3D volume representation data such as voxels and point clouds, the tri-plane feature representation requires less data amount and thus requires less storage space without sacrificing the 3D expressivity, and can allow faster model running speed. This can greatly save the resource costs in the model training and application. According to the target feature representation that can effectively characterize the 3D feature information of the target object, the 3D avatar of the target object is generated through a rendering process on the target feature representation. In this way, high-quality 3D avatars can be efficiently generated with reduced memory and computing costs.

Some example implementations of the subject matter described herein will be described in more detail below with reference to the accompanying drawings.

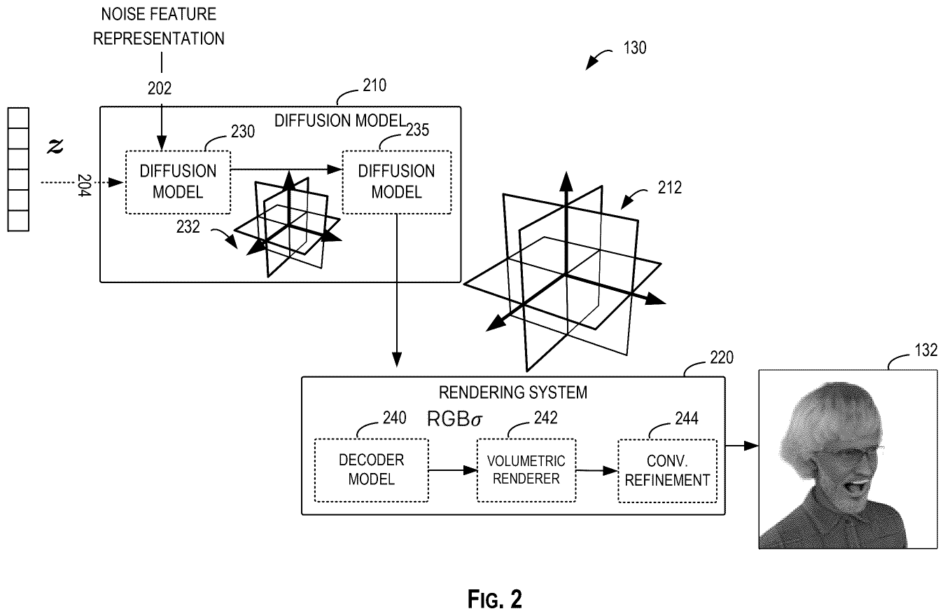

FIG. 2 illustrates a schematic block diagram of a system for 3D avatar generation in accordance with some implementations of the subject matter described herein. The system of FIG. 2 may be implemented, for example, as the system 105 of FIG. 1. As shown in FIG. 2, the system 105 includes a diffusion model 210 and a rendering system 220.

The various components and models in the system 105 may be implemented by hardware, software, firmware, or any combination thereof. Some specific examples of avatars, images and texts are shown in FIG. 2 and other figures, but this is only for the purpose of illustration without implying any limitations on the specific implementation of the subject matter described herein.

In the implementations of the subject matter described herein, the diffusion model 210 is trained to be capable of generating a target feature representation 212 from a predetermined input. The target feature representation includes a set of target feature maps corresponding to a tri-plane, respectively, to characterize feature information of a target object in a three-dimensional space. The target feature representation 212 is provided to the rendering system 220 for rendering a 3D avatar 132 of the target object.

Unlike 3D representation generation from a 2D image collection, the training data of the diffusion model 210 and the rendering system 220 are sample 3D avatars of sample objects. The learning objective is to learn 3D knowledge using multi-view rendering 3D volumes of sample objects. Compared with the model training in which images from different viewpoints of a same object are used as separate training samples, in the implementations of the subject matter described herein, a 3D avatar is modelled as a feature representation in the tri-plane form that can directly represent the feature information in the three-dimensional space, which can be used to explain the observations of the three-dimensional volume of the object from different viewpoints. The diffusion model 210 is used to characterize the distribution of the three-dimensional volume.

In the process of 3D avatar generation, high-quality feature representations of 3D avatars, especially the feature representations of 3D avatars with rich details, are to be learned with the sample 3D avatars as supervision information. A high-quality feature representation meets the following requirements. First, the feature representation needs to be an explicit representation of a 3D volume that can be amenable during the processing of the generative model. Second, it is expected that the feature representation is compact and memory efficient. Otherwise, it would be too costly to store a myriad of training data, and requires costly computational resources to improve the training speed. Moreover, the high cost of memory and computational resources will also restrict the application scenarios of the model.

At least based on the above considerations, in the implementations of the subject matter described herein, a three-dimensional volume of a 3D avatar to be generated is represented as a plurality of 2D feature maps in a tri-plane, also referred to as a tri-plane feature representation. Tri-plane refers to three axis-aligned orthogonal planes. The target feature representation 212 generated by the diffusion model 210 is represented as three axis-aligned orthogonal feature maps, as shown in FIG. 2, denoted as [symbol] ᵤᵥ, [symbol] _{wu}, [symbol] _{vw}∈ [symbol] ^{X×W×C}, each of which has a spatial resolution of H×W, and the number of channels in a feature map as C. Such a feature representation can effectively model a 3D volume of a 3D avatar, such as the neural radiance field of the 3D avatar, to represent the feature information of the target object in 3D space. Specifically, a 3D point in 3D space p∈ [symbol] ³ can be projected to each plane in the tri-plane and the features on the respective planes are aggregated to obtain feature information of this point, that is [symbol] ₚ= [symbol] ᵤᵥ(pᵤᵥ)+ [symbol] _{wu}(p_{uw})+ [symbol] _{vw}(p_{vw}).

As compared with 3D data such as voxel grid and point cloud, the tri-plane feature representation offers a considerably smaller memory footprint without sacrificing the expressivity of the 3D volumes. Therefore, the tri-plane feature representation is an explicit representation of rich 3D information.

The target feature representation 212 corresponding to the tri-plane can generate a 3D avatar 132 of the target object through a rendering process by the rendering system 220. In some implementations, the rendering system 220 may include a decoder model 240 and a volumetric render 242. The decoder model 240 may be configured to generate 3D information of the target object from the target feature representation 212. In some implementations, the 3D information may indicate color information and density information of a plurality of points of the target object in the 3D space, thereby describing the neural radiance field (NeRF) of the 3D avatar.

In some implementations, the decoder model 240 may be configured as a multilayer perceptron (MLP) model, denoted as

$${𝒢}_{θ}^{MLP} .$$

In the decoding process, given a certain viewpoint (or view direction) d∈ [symbol] ² for the target object, the color information (for example, in the RGB color space or other color spaces) c∈ [symbol] ³ and density information σ∈ [symbol] + of each 3D point of the target object can be determined from the target feature representation 212, which can be represented as follows:

$$c ( p , d ) , σ ( p ) = {𝒢}_{θ}^{MLP} ( {𝓎}_{p} , ξ ( {𝓎}_{p} ) , d ) \qquad ( 1 )$$

In above Equation (1), ξ(·) represents the Fourier embedding operator used to extract Fourier features, which can be applied onto feature information [symbol] ₚ of 3D points rather than spatial coordinates.

In the 3D avatar generation, it is expected that the tri-plane feature representations of different objects rigorously reside in the same domain. To achieve this, a shared decoder model is used when fitting distinct portraits, which can implicitly push the tri-plane feature representations generated by the diffusion model to the shared latent space domain recognizable by the decoder model.

Based on the 3D information of the target object, the volumetric render 242 can generate the 3D avatar 132 of the target object by volumetric rendering the 3D information. The volumetric render 242 may employ any suitable techniques to implement the rendering of 3D volumes. By changing the viewpoint d∈ [symbol] ², the 3D avatar representations of the target object in different viewpoints can be generated. In some implementations, the rendering system 220 may also include a convolution refinement module 244 for further refine the rendering result of the volumetric render 242, to produce the 3D avatar 132. The processing may be selected according to the actual requirements in the applications.

The overall framework of 3D avatar generation is described above. In the system 105, the parameter values of the diffusion model 210 and the decoder model 240 in the rendering system 220 may be optimized through the training process. In the implementations of the subject matter described herein, the training data of the models includes sample 3D avatars of sample objects. In some implementations, the diffusion model 210 and the decoder model 240 may be trained so that rendering results [symbol] = [symbol] (c, σ). of a feature representation generated by the diffusion model 210 from different viewpoints match with the images { [symbol] } Nᵥ of the 3D avatar of the sample object from different viewpoints, where [symbol] ∈ [symbol] H₀×W₀×3. The model training will be discussed in more detail below.

Next, the respective components in the system 105 will be described in detail.

As mentioned above, on the basis of the accurate representation of the 3D avatar, the rendering system 220 can decode and render the 3D avatar accordingly. Therefore, the process of 3D avatar generation is mainly to learn the distribution of tri-plane feature representations, that is p( [symbol] ), where [symbol] =( [symbol] ᵤᵥ, [symbol] _{wu}, [symbol] _{vw}). Such generative modelling is important since [symbol] is highly dimensional. In the implementations of the subject matter described herein, the diffusion model 210 is used to perform the generation of feature representation. The diffusion model can ensure stable and robust generation, high quality of generated results, and reduce the model collapse risk.

Before describing the generation of the feature representation, the diffusion model is briefly introduced first.

Diffusion model, also known as Denoising Diffusion Probabilistic Model, is a kind of generative model. The mechanism of common generative models (for example, GAN or VAE) is mainly to add information step by step given an input of a “limitation” (for example, type, style, or the like), and finally get the generation result (for example, image, audio, or the like). Different from the common generative models, the diffusion model “samples” a special distribution from noise information (for example, Gaussian noise) according to certain conditions step by step, and finally gets the generation result with the increase of “sampling” iterations. In other words, the generation process of diffusion model is to extract required data from noise through multiple iterations, and make sure that the quality of the generated data gets better with the increment of iteration steps. The input of the diffusion model includes Gaussian noise, and the output is the data to be generated.

In general, the modelling of diffusion model includes a forward diffusion process with gradual noise addition and a reverse diffusion process with gradual noise removal. The forward diffusion process can be represented as a Markov forward process. The expected data generation process corresponds to a reverse process, for example, by gradually reversing the Markov forward process to get the expected data.

FIG. 3 illustrates an example processing stream 300 of a diffusion model. In FIG. 3, the forward diffusion process is from right to left ( [symbol] ₀→ [symbol] _{T}). In each iteration step t=1, . . . , T (where T is an integer greater than or equal to 1), random noises are gradually added to corrupt the initial data. Each step in the forward process is a Gaussian transition q( [symbol] ₜ| [symbol] ₜ₋₁): = [symbol] (\sqrt{1−βₜ} [symbol] ₜ₋₁, βₜI), which

$${\{ {β}_{t} \}}_{t = 0}^{T}$$

are usually predefined variance values. Therefore, the intermediate output (also known as latent code or latent variable) [symbol] ₜ obtained in each iteration step t can be represented as:

$${x}_{t} = \sqrt{{α}_{t}} {x}_{0} + \sqrt{1 - {α}_{t}} w , w \sim 𝒩 ( 0 , I ) \qquad ( 2 )$$

where

$${α}_{t} := {\prod }_{s = 1}^{t} ( 1 - {β}_{s} ) .$$

when T is large enough, σ_{T} gets closer to 0, and the last output [symbol] _{T} is nearly an isotropic Gaussian distribution.

In FIG. 3, the reverse diffusion process is from left to right ( [symbol] T→ [symbol] ₀), and the noises are gradually removed in each iteration step. Each step q( [symbol] ₜ₋₁| [symbol] ₜ) of the reverse diffusion process can be considered as another Gaussian transition p_{θ}( [symbol] ₜ₋₁| [symbol] ₜ): = [symbol] ( [symbol] ᵢ₋ₗ; μ_{θ}( [symbol] ₜ, t), σ_{θ}( [symbol] ₜ, t)I), where μ_{θ}( [symbol] ₜ, t) can be decomposed into the linear combination of [symbol] ₜ with a noise approximation model ϵ_{θ}( [symbol] ₜ, t) which is the noise variance value. The noise approximation model ϵ_{θ}( [symbol] ₜ, t) may be obtained by solving the optimization problem as follows:

$${min}_{θ} {𝔼}_{{x}_{0} \sim q ( {x}_{0} ) , w \sim 𝒩 ( 0 , I ) , t} {‖ {ϵ}_{θ} ( {x}_{t} , t ) - w ‖}_{2}^{2} \qquad ( 3 )$$

In some implementations, σ_{θ}( [symbol] ₜ,t) in the diffusion model may be constant. In other implementations, neural networks can be used to learn σ_{θ}( [symbol] ₜ, t), which can achieve better data generation results. The learning objective of σ_{θ}( [symbol] ₜ, t) may be how to perform better interpolation between the upper and lower bounds of the fixed covariance.

In the inference phase of generating expected data, the following reverse diffusion process can may be used to sample the data to be generated:

$${x}_{t - 1} = \frac{1}{\sqrt{1 - {β}_{t}}} ( {x}_{t} - \frac{{β}_{t}}{\sqrt{1 - {α}_{t}}} {ϵ}_{θ} ( {x}_{t} , t ) ) + {σ}_{t} z \qquad ( 4 )$$

where z~ [symbol] (O, I) is the random sampling noise, σₜ represents the noise variance value. That is, the diffusion model used for data generation can generate the expected data, namely [symbol] ₀, through T iterations with random sampling noise z~ [symbol] (0, I) as the input.

The principle of diffusion model is briefly introduced above. In the implementations of the subject matter described herein, with respect to the problem of 3D avatar generation, the adopted diffusion model 210 is configured to generate a tri-plane feature representation [symbol] =( [symbol] ᵤᵥ, [symbol] _{wu}, [symbol] _{vw}).

For such a diffusion model 210, the forward diffusion process q is considered as starting from the desired tri-plane feature representation [symbol] ₀~p( [symbol] ) and generating the intermediate output (i.e., latent code or latent variable) { [symbol] ₜ|∈[0, T]} with gradual noise additions according to [symbol] ₜ:=αₜ [symbol] ₀+σₜϵ; ϵ∈ [symbol] (0, I) is the added Gaussian noise; αₜ and σₜ define a noise addition schedule in each iteration. In some implementations, the log signal-to-noise ratio corresponding to the noise addition method is determined as

$${λ}_{t} = log [ {α}_{t}^{2} / {σ}_{t}^{2} ] ,$$

which may decrease with the iteration step t. After noise additions for T times, a pure noise (for example, Gaussian noise) can be derived, namely [symbol] _{T}~ [symbol] (0, I).

The process of generating the tri-plane feature representation [symbol] by the diffusion model 210 is a reverse diffusion process corresponding to the reverse of the above noise addition process. The diffusion model 210 is trained to start from [symbol] _{T}~ [symbol] (0, I), and denoising 1; for all t, for example, using the mean square error loss, until [symbol] ₀ is obtained. That is, the input to the diffusion model 210 at least includes a noise feature representation 202 [symbol] _{T} (which is also in the form of tri-plane feature representation). In some examples, the input noise feature representation 202 [symbol] _{T} may be a noise sampled from a Gaussian noise distribution, where [symbol] _{T}~ [symbol] (0, I). In some implementations, starting from the Gaussian noise [symbol] _{T}~ [symbol] (0, I), tri-plane feature representations { [symbol] _{T}, [symbol] _{T-1}, . . . } with less noises may be generated sequentially, until the target feature representation [symbol] ₀ 202 is obtained.

In order to obtain better generation quality, in some implementations, the parameter values of the diffusion model can be updated through an optimization objective of predicting the noise added in each iteration step. The optimization objective may be represented as optimizing the following loss function:

$${ℒ}_{simple} = {𝔼}_{t , {x}_{0} , ϵ} \vert [ {‖ {\hat{ϵ}}_{θ} ( {α}_{t} {𝓎}_{0} + {σ}_{t} ϵ , t ) - ϵ ‖}_{2}^{2} ] \qquad ( 5 )$$

According to above Equation (5), in each iteration step t, the error between the noise predicted by the diffusion model \hat{ϵ}_{θ}, and the added actual noise ϵ∈ [symbol] (0, I) is used as a loss value for training. By gradually reducing or minimizing the loss value, the parameters of the diffusion model can be optimized. In addition to the loss function of above Equation (5), other loss functions can be additionally or alternatively used to train the diffusion model. For example, the parameter values of the diffusion model may be updated by optimizing the variational lower bound loss [symbol] _{VLB}. This loss function allows higher quality feature representation generation with fewer iterations. The training data of the diffusion model 210 and the specific training process will be described in detail below.

In some implementations, the diffusion model 210 may be constructed based on a convolutional neural network (CNN) that is suitable for processing visual data, with the CNN modelling the distribution of tri-plane feature representations from the sample 3D avatars through the reverse diffusion process. For example, the diffusion model 210 may include at least a plurality of convolutional layers for performing convolution processing. In addition to the convolutional layers, normal CNN may also include a pooling layer(s) for down sampling, a pooling layer(s) for up sampling, and so on. Different types of layers and the output dimensions of each layer may be configured according to the actual applications. In some implementations, CNN may also include residual blocks, where each residual block may combine the convolution results of the convolutional layers with additional information. The residual blocks may also be constructed according to actual applications. In some implementations, the diffusion model 210 may, for example, be based on a U-Net architecture. In some implementations, other CNN architectures may also be adopted to implement the diffusion model 210. The implementations of the subject matter described herein are not limited in this regard.

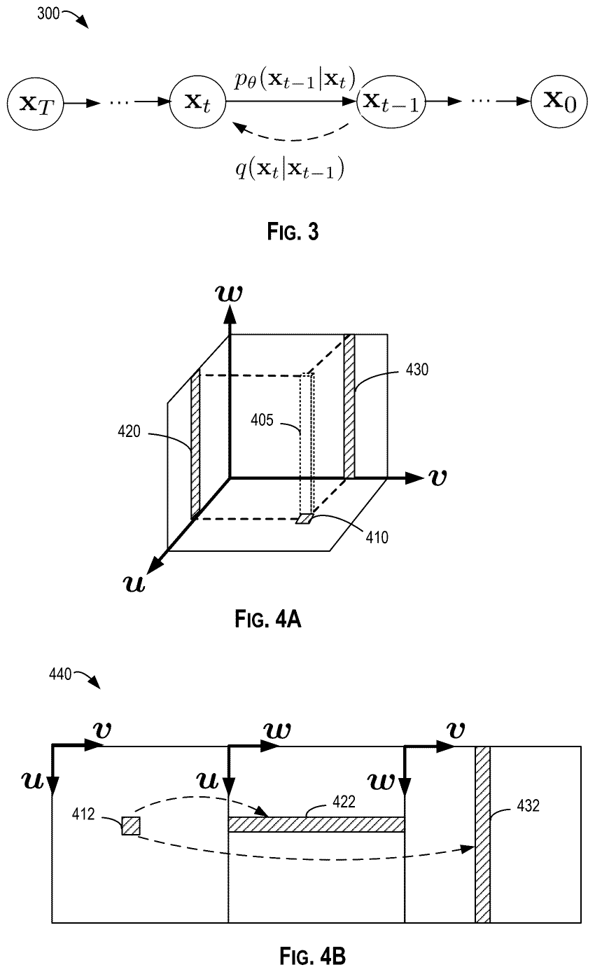

As mentioned above, a feature representation in the form of tri-plane is considered as including three feature maps corresponding to the tri-plane respectively, i.e., [symbol] ᵤᵥ, [symbol] _{wu}, [symbol] _{vw}∈ [symbol] ^{H×W×C}, each of which has a spatial resolution H×W, and the number of channels in a feature map as C. In the CNN-based diffusion model 210, the feature representation in the tri-plane form may need to be processed from the input so as to produce the final output. According to the processing method of normal CNN, these feature maps will be concatenated in the channel dimension to form [symbol] =( [symbol] ᵤᵥ⊕ [symbol] _{wu}⊕ [symbol] _{vw})∈ [symbol] ^{H×W×3C}, on which the convolution is performed. However, the inventors found by experiments that such convolution will lead to artifacts in the resulting 3D avatars. The inventors found that such artifacts may come from the incompatibility between the normal convolution processing and the tri-plane feature representations. As shown in FIG. 4A, the three feature maps in the triplane may be considered as the projection of the three-dimensional volume towards the frontal, bottom, and side views, respectively. For example, in FIG. 4A, a three-dimensional volume 405 is projected to a point 410 in the uv plane, a line 420 in the wu plane, and a line 430 in the vw plane. However, the channel-wise concatenation of feature maps in these orthogonal planes for convolution processing is problematic because these planes are not spatially aligned. Therefore, the convolution of the channel-wise concatenated tri-plane feature maps will make features that are theoretically unrelated in the 3D space to convolve each other.

To better handle the convolution of the tri-plane feature representations, 3D-aware convolution is proposed in some implementations of the subject matter described herein. Specifically, the feature maps corresponding to the triplane may be spatially rolled out and concatenated. For example, these feature maps may be concatenated along the horizontal (W) or vertical (H) direction of the feature maps. In the following, concatenation along the horizontal direction W will be discussed as an example and then a concatenated feature map may be represented as [symbol] =hstack( [symbol] ᵤᵥ; [symbol] _{wu}, [symbol] _{vw})∈ [symbol] ^{H×3W×C}, where hstack ( ) represents a concatenation function to concatenate the second dimension (that is, the dimension W) of data with three dimensions (H, W, and C). Such feature map rolling out allows independent processing of feature maps in different planes. In the following, for the convenience of description, the symbol y is used to represent this form of concatenated feature map. The convolutional layers and other layers in the diffusion model 210 each process this form of concatenated feature map.

To better handle the feature map of tri-plane, convolution operations for individual planes are needed, rather than treating a concatenated feature map as a plain two-dimensional input. Therefore, in some implementations of the subject matter described herein, 3D-aware convolution processing is proposed to take into account the 3D spatial relationship between the feature maps corresponding to the tri-plane. Specifically, by considering the spatial relationship of the projection of the three-dimensional volume 405 in FIG. 4A on the tri-plane, if the three feature maps of the tri-plane feature representation are rolled out along the W dimension, a concatenated feature map 440 can be obtained as shown in FIG. 4B. In the concatenated feature map 440, according to the 3D projection principle, a feature point 412 in the feature map yuv corresponding to the uv plane is associated with a row of feature points 422 in the feature map ywu corresponding to the wu plane and a column of feature points 432 in the feature map [symbol] _{vw} corresponding to the vw plane. When performing the convolution, it is expected that a convolution operation for the feature point 412 is performed based at least on the feature point 412, the row of feature points 422, and the column of feature points 432.

In some examples, the convolution operation may also consider some feature points located around the feature point 412 in the feature map corresponding to the same plane. For each feature point in the feature map [symbol] ᵤᵥ, the relevant feature points in the feature maps of the other two planes may also be taken into account in the convolution operation. Similar convolution operation may be performed for each feature point in the feature maps [symbol] _{wu} and [symbol] _{vw}.

Since the feature points at the corresponding positions in the tri-plane together describe the same three-dimensional volume, using these feature points jointly to perform the convolution can extract better feature information of the three-dimensional volume. In addition, since the convolution operation is performed in the rolled out concatenated feature map, the two-dimensional convolution operation may also be applied to achieve the effect of three-dimensional processing. Compared with the three-dimensional convolution that is usually required when modelling a high-resolution three-dimensional volume, the 3D-aware convolution of the subject matter described herein can greatly simplify the convolution and reduce the processing overhead.

In the example of FIG. 4B, for each feature point in a given plane, the corresponding two sets of feature points may be detected from the other two planes to perform the convolution operation. In some implementations, in order to further improve the convolution efficiency, especially to achieve parallel computing, the 3D-aware convolution may be further improved. Specifically, in order to calculate the convolution for the feature map [symbol] ᵤᵥ, axis-wise pooling can be performed for the feature maps [symbol] _{wu} and [symbol] _{vw}. Since each row of feature points in the feature map [symbol] _{wu} are relevant to a feature point in the feature map [symbol] ᵤᵥ, the feature points in each row of the feature map [symbol] _{wu} may be row-wise aggregated to obtain a single feature-point aggregated column (i.e., in the form of a column vector), which is represented as [symbol] _{wu→u}∈ [symbol] ^{I×W×C}. In the row-wise aggregation, the values of each row of feature points may be aggregated in any suitable aggregation fashions, such as averaging, calculating a median, or the like, to produce an element in the feature-point aggregated column. Similarly, since each column of feature points in the feature map [symbol] _{vw} are relevant to a feature point in the feature map [symbol] ᵤᵥ, each column of feature points in the feature map may be column-wise aggregated to obtain a single feature-point aggregated row (i.e., in the form of a row vector), which is represented as [symbol] _{vw→v}∈ [symbol] ^{H×1×C}. In the column-wise aggregation, the values of each column of feature points may be aggregated in any suitable aggregation fashions, such as averaging, calculating median, or the like, to produce an element in the feature-point aggregated row. In this way, the feature-point aggregated column and feature-point aggregated row after the aggregation may be directly accessed for the convolution of each feature point in the feature map [symbol] ᵤᵥ. This can enhance the efficiency of finding relevant feature points from the other two feature maps for convolution calculation and allow parallel convolution calculation for multiple feature points. For the convolution processing of feature maps [symbol] _{wu} and [symbol] _{uw}, feature-point aggregated columns and feature-point aggregated rows may be similarly pre-built to accelerate the processing.

Further, for the feature map [symbol] ᵤᵥ, the feature-point aggregated column and the feature-point aggregated row may also be expanded to the original 2D dimension of H×W. Specifically, the feature-point aggregated column may be column-wise replicated to obtain an aggregated feature map [symbol] (·)ᵤ with a same size as the feature map [symbol] _{wu}. Similarly, the feature-point aggregated row may be row-wis replicated to obtain an aggregated feature map [symbol] v(·) with a same size as the feature map [symbol] _{vw}. That is, the respective element values of feature points in a column are the same as those in the other column in [symbol] (·)ᵤ, and the element values of feature points in a row are the same as those of the feature points in the other row in [symbol] ᵥ(·) In addition, [symbol] _{(·)u}, [symbol] _{v(·)}∈ [symbol] ^{H×W×C}. Then, the feature map [symbol] ᵤᵥ, the aggregated feature map [symbol] _{(·)u} and [symbol] _{v(·)} may be channel-wise concatenated to obtain a channel-wise concatenated map, and a 2D convolution operation may be performed on the channel-wise concatenated map, that is, Conv2D ( [symbol] ᵤᵥ⊕ [symbol] _{(·)u}⊕ [symbol] _{v(·)}). Since [symbol] ᵤᵥ is now spatially aligned with the constructed feature maps [symbol] ᵥ(·) and [symbol] (·)ᵤ, the conventional 2D convolution operator may be used to perform the convolution. For the convolution processing of feature maps [symbol] _{wu} and [symbol] _{vw}, aggregated feature maps may be similarly constructed to perform 2D convolution operations.

The 3D-aware convolution has been described above. In some implementations, the convolutional layers in the diffusion model 210 may perform the 3D-aware convolution as discussed above. In a current convolutional layer, a given input to this convolutional layer is considered as a concatenated feature map which is determined by concatenating the feature maps corresponding to the tri-plane along the horizontal direction W or the vertical direction H. After the above 3D-aware convolution, another concatenated feature map may be obtained and provided to a next network layer of the diffusion model 210 for further processing until the target feature representation is output from the last network layer of the diffusion model 210.

The above 3D-aware convolution can not only greatly improve the quality of 3D avatar generation and reduce generation artifacts, but also avoid computational complexity and improve the processing efficiency.

In some implementations, in order to generate high-fidelity 3D structures, the diffusion model 210 may be constructed to implement hierarchical feature representation generation from coarse to fine granularities. As shown in FIG. 2, the diffusion model 210 may include a diffusion model 230 corresponding to a first resolution and a diffusion model 235 corresponding to a higher second resolution. The diffusion model 230 starts from the initial model input and generates an intermediate feature representation 232 corresponding to the tri-plane. The intermediate feature representation 232 includes a set of intermediate feature maps corresponding to the tri-plane respectively, and an intermediate feature map has the first resolution. The intermediate feature representation 232 is provided to the diffusion model 235. The diffusion model 235 generates the target feature representation 212 from the intermediate feature representation 232. A target feature map in the target feature representation 212 has the second resolution, where the second resolution is greater than the first resolution. That is, the diffusion model 235 is used to up sample the output of the diffusion model 230, which is also referred as a diffusion upsampler. For example, the first resolution may be 64×64, i.e., the dimensions H and W of an intermediate feature map are both 64, while the second resolution may be 256×256, i.e., the dimensions H and W of a target feature map are both 256. Of course, this is only an example, and the first and the second resolutions may be set to any other suitable resolutions according to the applications.

In some implementations, the diffusion model 230 may be configured to operate according to the principle of the base diffusion model described above, to generate the intermediate feature representation 232 from the initial noise. The diffusion model 235 is configured to generate the final target feature representation 235 on the condition of the intermediate feature representation 232 output by the diffusion model 230. The processing of the diffusion model 235 may be represented as

$${𝓎}_{θ}^{HR} ( {𝓎}_{t}^{HR} , {𝓎}^{LR} , t ) ,$$

where [symbol] ^{LR} represents the intermediate feature representation with the first resolution (the low resolution) output by the diffusion model 230, and

$${𝓎}_{t}^{HR}$$

represents the feature representation generated by the diffusion model 235 in the t^{th} iteration step. In some implementations, the diffusion model 230 and the diffusion model 235 may be both based on CNN, for example, may be constructed as U-Net or other architectures. The convolutional layers in the diffusion model 230 and in the diffusion model 235 can adopt the 3D-aware convolution as discussed above.

In some implementations, the training of the diffusion model 230 may be based on the training fashion of the conventional diffusion model as discussed above, to update the parameter values of the model by predicting the noise added in each iteration step. Different from the diffusion model 230, the training of the diffusion model 235 is configured to predict sample target feature representations generated from the sample 3D avatars that are used for training.

Specifically, for a sample 3D avatar of a sample object in the training data, a sample intermediate feature representation with the first resolution and a sample target feature representation with the second resolution may be generated. The sample intermediate feature representation includes a first set of sample feature maps with the first resolution corresponding to the tri-plane, and the sample target feature representation includes a second set of sample feature maps with the second resolution corresponding to the tri-plane. In some implementations, a transformation relationship from 3D avatars to tri-plane feature representations of the different resolutions may be pre-determined by fitting for use in processing the sample 3D avatars in the training data.

The sample intermediate feature representation of the first resolution may be used as an input to the diffusion model 235, and the sample target feature representation of the second resolution may be used as a ground-truth result of the input sample intermediate feature representation, namely, supervision information. For the diffusion model 235 to be trained, a predicted feature representation may be generated from the sample intermediate feature representation, and an error between the generated predicted feature representation and the sample target feature representation may be calculated. The diffusion model 235 is updated based on this error. The diffusion model 235 is updated in such a way that the error is gradually reduced to a minimum value or reaches a predetermined goal.

In some implementations, since the rendering result of the ground-truth 3D avatar of the sample object is known, a predicted 3D avatar of the sample object may also be generated based on a rendering process of the sample target feature representation. Then, the diffusion model 235 is updated based on an error between the predicted 3D avatar and the ground-truth 3D avatar of the sample object, with the ground-truth 3D avatar used as the supervision information. The diffusion model 235 is updated in such a way that the error is gradually reduced to a minimum value or reaches a predetermined goal. In some implementations, the error between the 3D avatars may be determined as an error between image features extracted from the rendered images.

Specifically, the rendering result of the ground-truth 3D avatar of the sample object may be obtained as [symbol] ∈ [symbol] ^{H}^{₀}^{×W}^{₀}^{×3}. The rendering process based on the predicted target feature representation

$${\hat{𝓎}}_{0}^{HR}$$

output from the diffusion model 235 may produce the rendering result of the predicted 3D avatar of the sample object

$$\hat{x} = ℛ ( {𝒢}_{θ}^{MLP} ( {\hat{𝓎}}_{0}^{HR} ) ) .$$

The error between the two rendering results may be represented as follows:

$${ℒ}_{perc} = {𝔼}_{t , \hat{x}} {\sum }_{l} {‖ {Ψ}^{l} ( \hat{x} ) - {Ψ}^{l} ( x ) ‖}_{2}^{2} \qquad ( 6 )$$

where Ψ^{l} represents a pre-trained image feature extraction model, used for extracting respective image features from the rendered images [symbol] and [symbol] for error comparison. According to Equation (6) above, the error between the rendering results is taken as a training loss value for the diffusion model 235. By gradually reducing or minimizing the loss value, the parameters of the diffusion model may be optimized. Generally, volumetric rendering requires full sampling along each ray, which is computationally expensive for high-resolution rendering. In view of this, in some implementations, in order to save the training resources, only a part but not all of the 3D avatar are rendered to calculate the above error [symbol] _{perc}. The part selected for rendering may be important to a 3D avatar, such as the face of a character.

In some implementations, similar to the diffusion model 235, the error between the rendering results are also considered in the training of the diffusion model 230. Specifically, the sample intermediate feature representation output from the diffusion model 230 may be rendered to obtain a predicted 3D avatar of the sample object. The diffusion model 230 is then also updated based on the error between the predicted 3D avatar and the ground-truth 3D avatar of the sample object. The calculation of the error for the diffusion model 230 is similar to that for the diffusion model 235, which is not repeated here.

In some implementations, considering that the initial input of the diffusion model 210 is the noise feature representation 202 sampled from the noise distribution, in order to coordinate the feature maps for the tri-plane in the generation process, referring to FIG. 2, constraint information z 204 is additionally input as a condition constraint for the target object to be generated. The diffusion model 210 may be configured to perform conditional generation and generate the target feature representation 212 under the condition of the constraint information z. The constraint information z is referred to as a latent condition. In some implementations, the diffusion model 210 may include one or more residual blocks, and the constraint information z 204 may be input into at least one of the residual blocks for aggregation with intermediate information generated within the diffusion model 210. In some implementations, the constraint information z 204 may be injected to each residual block of the diffusion model 210. In this way, each feature map of the tri-plane may be synchronously generated according to the shared constraint information. Such constraint information can not only achieve better generation quality, but also help to achieve semantic editing of the generated results.

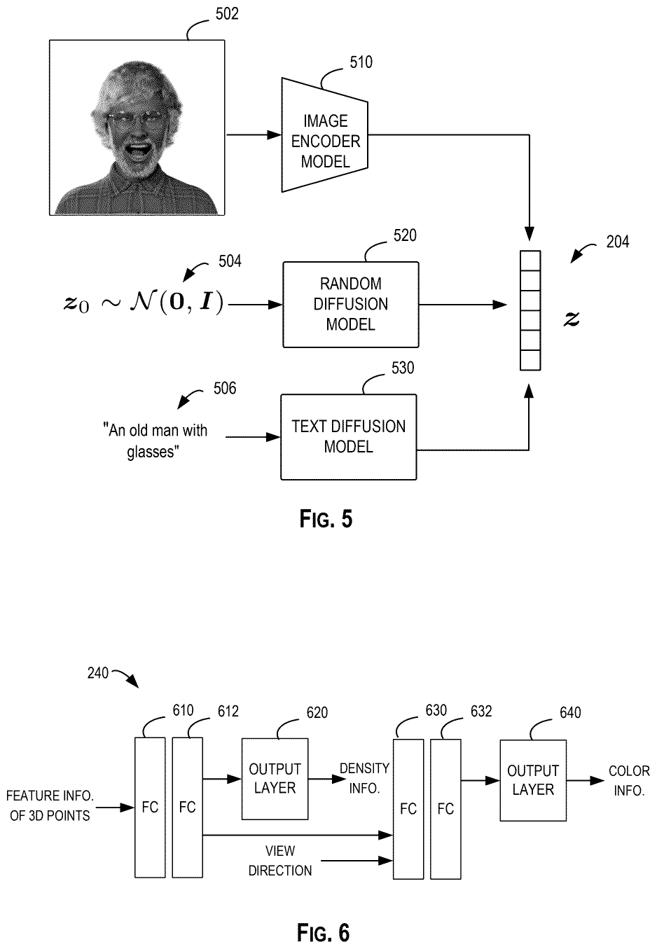

FIG. 5 illustrates an example model for generating the constraint information z 204. In some implementations, image feature information may be extracted from a reference image 502 for use as the constraint information z 204. A trained image encoder model 510 may be used to extract the image feature information from the reference image 502. The image encoder model 510 may be configured as a model suitable for processing image data.

In some implementations, noise information may be extracted from a random noise distribution 504 for use as the constraint information z 204. The random noise distribution may include, for example, a Gaussian distribution, for example, z₀~ [symbol] (0, I). A trained random diffusion model 520 may be used to extract the noise information from the random noise distribution 504. In some implementations, text feature information may be extracted from reference text 506 for use as the constraint information z 204. A trained text diffusion model 530 may be used to extract the text feature information from the reference text 506. The random diffusion model 520 and the text diffusion model 530 respectively generate the constraint information according to the principle of the diffusion model.

In some implementations, the reference image 502 and the reference text 506 may be provided by the user, which can facilitate convenient use control of the 3D avatar 132 to be generated. It is noted that the image and text shown in FIG. 5 are only examples. In some implementations, in addition to automatically generating the constraint information z 204 from these models, the constraint information z 204 may also be edited, modified, and provided in other ways. For example, specific constraint information z may be generated by feature engineering to guide and control the generation of desired 3D avatars.

Various models included in the system 105 for 3D avatar generation in various implementations are described above. In some implementations, these models may be trained independently, where the training data of the diffusion model 230, the diffusion model 235, and the decoder model 240 in the rendering system 220 are based on the sample 3D avatars of the sample objects.

In some implementations, if the error between the generated predicted rendering result and the ground-truth rendering result is considered during the training of the diffusion model 235 and/or the diffusion model 230, the decoder model 240 may be trained first based on the sample 3D avatars of the sample objects so as to enable generating the rendering results. FIG. 6 illustrates an example result of MLP-based decoder model 240. As described above, given a view direction, the decoder model 240 determine color information and density information of respective 3D points of the target object from the features of the respective 3D points in the target feature representation 212 output from the diffusion model 210, referring to Equation (1).

As shown in FIG. 6, the decoder model 240 may include a plurality of fully connected (FC) layers that are connected sequentially, such as FC layers 610 and 612. The input to the FC layer 610 is feature information [symbol] ₚ of 3D points p∈ [symbol] ³ obtained from the target feature representation 212. After processing by the FC layers 610 and 612, the output of the FC layer 612 is provided to an output layer 620 to determine density information of the 3D points σ(p). In some implementations, the output layer 620 may determine the density information based on the Softplus function. The Softplus function may be represented as Softplus (x)=log (1+e^{x}), where x represents the input to the function. The output of the FC layer 612 and the view direction of the 3D avatar to be rendered are provided to a subsequent FC layer 630 as input. After processing by the FC layers 630 and 632, the output of FC layer 632 is provided to an output layer 640 to determine the color information of 3D points c (p, d). In some implementations, the output layer 640 may determine the color information based on the Sigmoid function. The Sigmoid function may be represented as

$$S ( x ) = \frac{1}{1 + {e}^{- x}} ,$$

where x represents the input to the function.

It should be understood that in addition to the Softplus and Sigmoid functions, other suitable activation functions may be selected as far as the desired density information and color information can be determined. Although FIG. 6 illustrates several FC layers in the decoder model 240, the number of FC layers may be set according to application requirements and/or other types of network layers may be included. The implementations of the subject matter described herein are not limited in this respect.

During the training, a sample target feature representation may be generated from a sample 3D avatar of a sample object as input to the decoder model 240. The decoder model 240 may generate, based on the current parameter values, predicted color information and density information of the three-dimensional volume of the sample object from the sample target feature representation for rendering and generation of the predicted 3D avatar by the volumetric render 242 and the subsequent components. Then, the decoder model 240 is updated based on the error between the rendering result and the ground-truth rendering result of the sample 3D avatar. This process iterates until the rendering error is minimized or the error can reach the desired objective.

Furthermore, in some implementations, the generated 3D avatars are expected to be robust. In other words, the decoder model can tolerate small disturbance of the feature representations provided by the diffusion model and generate relatively reliable results even if the generated tri-plane feature representations are not ideal. In addition, it is expected that the decoder model may be robust to feature maps of different resolutions corresponding to the tri-plane because the multi-resolution feature maps may be used for training the diffusion model. For this reason, during the model training, in order to ensure that the decoder model 240 is robust to the tri-plane feature representations of different resolutions, the sample target feature representations may be randomly down sampled for training the decoder model 240. This enables processing feature representations of different resolutions with the same decoder for efficient rendering.

In some implementations, if the input of the diffusion model 230 also includes constraint information, the diffusion model 230 and the image encoder model 510 may be trained jointly. During the training, the input of the image encoder model 510 includes an image corresponding to a sample 3D avatar of a sample object, such as a rendered image of the sample 3D avatar. In some implementations, the pre-trained image encoder model 510 may also be used for fine-tuning. During the training of the diffusion model 230, the supervision information for the output of the diffusion model 230 is a sample intermediate feature representation generated from the sample 3D avatar of the sample object. In the case where the rendering error is taken into account, the rendering result of the ground-truth sample 3D avatar may also be used as the supervision information. In some implementations, during the training of the diffusion model 230, the constraint information z may also be randomly set to 0 with a certain probability (for example, 20%), so that the diffusion model 230 can learn how to generate target feature representation without constraint information. With respect to such training, in the model inference stage, the results in the model generation may be controlled as follows:

$${\hat{ϵ}}_{θ} ( 𝓎 , z ) = {λϵ}_{θ} ( 𝓎 , z ) + ( 1 - λ ) {ϵ}_{θ} ( 𝓎 ) \qquad ( 7 )$$

where ϵ_{θ}( [symbol] , z) represents the generation process under the condition of constraint information z, ϵ_{θ}( [symbol] ) represents the generation process without the condition, and λ>0 may be used to control the guidance strength to the generation process with the constraint information. Through such training, the diffusion model 230 may support both conditional generation and unconditional generation. In addition, by adding the noise information provided by the trained noise diffusion model 520 into the system 105 as the constraint information z, the distribution of the constraint information z may be better modelled, and [symbol] T of the noise diffusion model 520 may describe the residual variation.

In some implementations, the noise diffusion model 520 and the text diffusion model 530 may be trained separately according to the training method for the normal diffusion model.

It has been provided above some ways of determining the training data for the models and some examples of the model training process. In some implementations, the training of these models may be completed centrally or distributed via specific model training devices or systems and then provided to a device for 3D avatar generation for use.

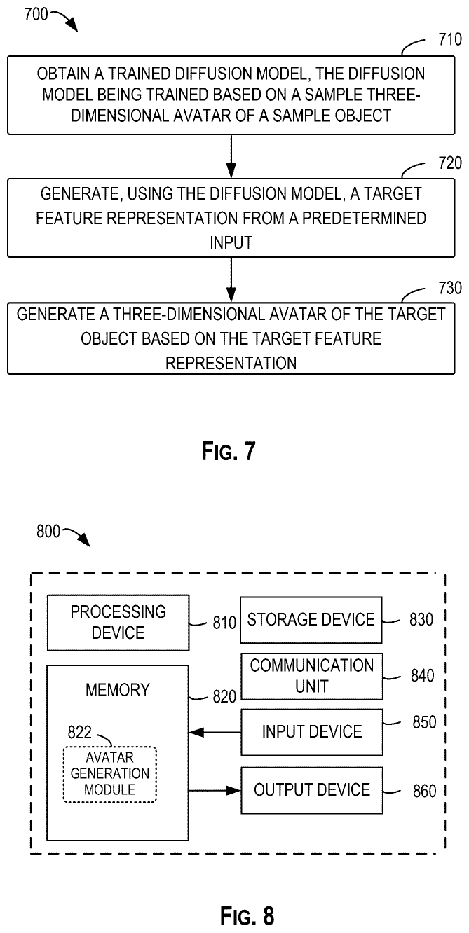

FIG. 7 illustrates a flowchart of a process 700 for 3D avatar generation in accordance with some implementations of the subject matter described herein. The process 700 may be implemented at the system 105 of FIG. 2.

At block 710, the system 105 obtains a trained diffusion model, the diffusion model being trained based on a sample three-dimensional avatar of a sample object.

At block 720, the system 105 generates, using the diffusion model, a target feature representation from a predetermined input. The target feature representation comprises a set of target feature maps corresponding to a tri-plane, respectively, to characterize feature information of a target object in a three-dimensional space.

At block 730, the system 105 generates a three-dimensional avatar of the target object based on the target feature representation.

In some implementations, the diffusion model comprises a plurality of convolutional layers. In some implementations, generating the target feature representation comprises: for a given convolutional layer of the plurality of convolutional layers, determining a given input for the given convolutional layer from the predetermined input, the given input comprising a first concatenated feature map determined by concatenating a set of feature maps corresponding to the tri-plane in a horizontal or vertical direction; performing convolution processing on the first concatenated feature map using the given convolutional layer, to obtain a second concatenated feature map; and generating the target feature representation based on the second concatenated feature map.

In some implementations, in the convolution processing, for a given feature point in a first feature map of the first concatenated feature map corresponding to a first plane of the tri-plane, a convolution operation for the given feature point is performed at least based on the given feature point, a first set of feature points in a second feature map corresponding to a second plane of the tri-plane, and a second set of feature points in a third feature map corresponding to a third plane of the tri-plane. The first set of feature points comprises a row of feature points on a first projection line of the second feature map for the given feature point, and the second set of feature points comprises a column of feature points on a projection line of the third feature map for the given feature point.

In some implementations, performing the convolution processing comprises: for the first feature map, row-wise aggregating a plurality of rows of feature points in the second feature map, to obtain a feature-point aggregated column; column-wise aggregating a plurality of columns of feature points in the third feature map, to obtain a feature-point aggregated row; and for each feature point in the first feature map, performing convolution processing based on the feature point, the feature-point aggregated column, and the feature-point aggregated row.

In some implementations, performing the convolution processing based on the feature point, the feature-point aggregated column, and the feature-point aggregated row comprises: column-wise replicating the feature-point aggregated column to obtain a first aggregated feature map with a same size as the second feature map; row-wise replicating the feature-point aggregated row to obtain a second aggregated feature map with a same size as the third feature map; and performing a two-dimensional convolution operation on a channel-wise concatenated map of the first feature map, the first aggregated feature map, and the second aggregated feature map.

In some implementations, the predetermined input comprises a noise feature representation and constraint information for the target object, and wherein generating the target feature representation comprises: generating, using the diffusion model, the target feature representation from the noise feature representation under a condition of the constraint information.

In some implementations, the diffusion model comprises at least one residual block, and generating the target feature representation from the noise feature representation comprises inputting the constraint information into one or more of the at least one residual block.

In some implementations, the constraint information comprises at least one of the following: image feature information extracted from a reference image using a trained image encoder model, text feature information extracted from reference text using a trained text diffusion model, or noise information extracted from a random noise distribution using a trained random diffusion model.

In some implementations, the diffusion model comprises a first diffusion model and a second diffusion model, and wherein generating the target feature representation comprises: generating, using the first diffusion model, an intermediate feature representation from the predetermined input, the intermediate feature representation comprising a set of intermediate feature maps with a first resolution corresponding to the tri-plane, respectively; and generating, using the second diffusion model, the target feature representation from the intermediate feature representation, the target feature map in the target feature representation having a second resolution greater than the first resolution.

In some implementations, training of the second diffusion model comprises: obtaining a sample intermediate feature representation and a sample target feature representation generated from the sample three-dimensional avatar, the sample intermediate feature representation comprising a first set of sample feature maps with the first resolution corresponding to the tri-plane, respectively, and the sample target feature representation comprising a second set of sample feature maps with the second resolution corresponding to the tri-plane, respectively; generating, using the second diffusion model, a predicted feature representation from the sample intermediate feature representation; and updating the second diffusion model at least based on a first error between the predicted feature representation and the sample target feature representation.

In some implementations, the training of the second diffusion model further comprises: generating a predicted three-dimensional avatar of the sample object based on a rendering process for the predicted feature representation; and updating the second diffusion model further based on a second error between the predicted three-dimensional avatar and the sample three-dimensional avatar.

In some implementations, generating the three-dimensional avatar of the target object comprises: generating, using a trained decoding model, three-dimensional information of the target object from the target feature representation, the three-dimensional information indicating color information and density information of a plurality of points of the target object in a three-dimensional space; and generating the three-dimensional avatar of the target object through volumetric rendering of the three-dimensional information.

FIG. 8 illustrates a schematic block diagram of an electronic device in which various implementations of the subject matter described herein can be implemented. It would be appreciated that the electronic device 800 as shown in FIG. 8 is merely provided as an example, without suggesting any limitation to the functionalities and scope of implementations of the subject matter described herein.

As shown in FIG. 8, the electronic device 800 is in form of a general-purpose computing device. Components of the electronic device 800 may include, but are not limited to, one or more processors or processing devices 810, a memory 820, a storage device 830, one or more communication units 840, one or more input devices 850, and one or more output devices 860.

In some implementations, the electronic device 800 may be implemented as a device with computing capability, such as a computing device, a computing system, a server, a mainframe and so on.

The processing device may can be a physical or virtual processor and can execute various processing based on the programs stored in the memory 820. In a multi-processor system, a plurality of processing units execute computer-executable instructions in parallel so as to enhance the parallel processing capability of the electronic device 800. The processing device 810 may include a central processing unit (CPU), a graphics processing unit (GPU), a microprocessor, a controller, and/or a microcontroller, etc.

The electronic device 800 usually includes various computer storage medium. Such medium may be any available medium accessible by the electronic device 800, including but not limited to, volatile and non-volatile medium, or detachable and non-detachable medium. The memory 820 may be a volatile memory (for example, a register, cache, Random Access Memory (RAM)), non-volatile memory (for example, a Read-Only Memory (ROM), Electrically Erasable Programmable Read-Only Memory (EEPROM), a flash memory), or any combination thereof. The storage device 830 may be any detachable or non-detachable medium and may include computer-readable medium such as a memory, a flash memory drive, a magnetic disk or any other medium that can be used for storing information and/or data and are accessible by the electronic device 800.

The electronic device 800 may further include additional detachable/non-detachable, volatile/non-volatile memory medium. Although not shown in FIG. 8, there may be provided a disk drive for reading from or writing into a detachable and non-volatile disk, and an optical disk drive for reading from and writing into a detachable non-volatile optical disc. In such cases, each drive may be connected to a bus (not shown) via one or more data medium interfaces.

The communication unit 840 implements communication with another computing device via communication medium. In addition, the functionalities of the components in the electronic device 800 may be implemented by a single computing cluster or a plurality of computing machines that can communicate with each other via communication connections. Thus, the electronic device 800 may operate in a networked environment using a logic connection with one or more other servers, network personal computers (PCs), or further general network nodes.

The input device 850 may include one or more of a variety of input devices, such as a mouse, keyboard, data import device and the like. The output device 860 may be one or more output devices, such as a display, data export device and the like. By means of the communication unit 840, the electronic device 800 may further communicate with one or more external devices (not shown) such as storage devices and display devices, one or more devices that enable the user to interact with the electronic device 800, or any devices (such as a network card, a modem and the like) that enable the electronic device 800 to communicate with one or more other computing devices, if required. Such communication may be performed via input/output (I/O) interfaces (not shown).

In some implementations, as an alternative of being integrated on a single device, some or all components of the electronic device 800 may also be arranged in the form of cloud computing architecture. In the cloud computing architecture, the components may be provided remotely and work together to implement the functionalities described in the subject matter described herein. In some implementations, the cloud computing provides computing, software, data access and storage service, which will not require end users to be aware of the physical locations or configurations of the systems or hardware provisioning these services. In various implementations, the cloud computing provides the services via a wide area network (such as Internet) using proper protocols. For example, a cloud computing provider provides applications over the wide area network, which may be accessed through a web browser or any other computing components. The software or components of the cloud computing architecture and corresponding data may be stored in a server at a remote position. The computing resources in the cloud computing environment may be aggregated or distributed at locations of remote data centers. Cloud computing infrastructure may provide the services through a shared data center, though they behave as a single access point for the users. Therefore, the cloud computing infrastructure may be utilized to provide the components and functionalities described herein from a service provider at remote locations. Alternatively, they may be provided from a conventional server or may be installed directly or otherwise on a client device.

The electronic device 800 may be used to implement resource management in accordance with various implementations of the subject matter described herein. The memory 820 may include one or more modules having one or more program instructions. These modules may be accessed and run by the processing unit 810 to perform functions of various implementations described herein. For example, the memory 820 may include an avatar generation module 822 for performing management of resources for a specific processing unit. As shown in FIG. 8, the electronic device 800 may obtain an input required for resource management through the input device 850 and provide an output of resource management through the output device 860. In some implementations, the electronic device 800 may further receive an input from other device (not shown) via the communication unit 840.

Some example implementations of the subject matter described herein are listed below.

In an aspect, the subject matter described herein provides a computer-implemented method. The method comprises: obtaining a trained diffusion model, the diffusion model being trained based on a sample three-dimensional avatar of a sample object; generating, using the diffusion model, a target feature representation from a predetermined input, the target feature representation comprising a set of target feature maps corresponding to a tri-plane, respectively, to characterize feature information of a target object in a three-dimensional space; and generating a three-dimensional avatar of the target object based on the target feature representation.

In some implementations, the diffusion model comprises a plurality of convolutional layers. In some implementations, generating the target feature representation comprises: for a given convolutional layer of the plurality of convolutional layers, determining a given input for the given convolutional layer from the predetermined input, the given input comprising a first concatenated feature map determined by concatenating a set of feature maps corresponding to the tri-plane in a horizontal or vertical direction; performing convolution processing on the first concatenated feature map using the given convolutional layer, to obtain a second concatenated feature map; and generating the target feature representation based on the second concatenated feature map.

In some implementations, in the convolution processing, for a given feature point in a first feature map of the first concatenated feature map corresponding to a first plane of the tri-plane, a convolution operation for the given feature point is performed at least based on the given feature point, a first set of feature points in a second feature map corresponding to a second plane of the tri-plane, and a second set of feature points in a third feature map corresponding to a third plane of the tri-plane. The first set of feature points comprises a row of feature points on a first projection line of the second feature map for the given feature point, and the second set of feature points comprises a column of feature points on a projection line of the third feature map for the given feature point.

In some implementations, performing the convolution processing comprises: for the first feature map, row-wise aggregating a plurality of rows of feature points in the second feature map, to obtain a feature-point aggregated column; column-wise aggregating a plurality of columns of feature points in the third feature map, to obtain a feature-point aggregated row; and for each feature point in the first feature map, performing convolution processing based on the feature point, the feature-point aggregated column, and the feature-point aggregated row.

In some implementations, performing the convolution processing based on the feature point, the feature-point aggregated column, and the feature-point aggregated row comprises: column-wise replicating the feature-point aggregated column to obtain a first aggregated feature map with a same size as the second feature map; row-wise replicating the feature-point aggregated row to obtain a second aggregated feature map with a same size as the third feature map; and performing a two-dimensional convolution operation on a channel-wise concatenated map of the first feature map, the first aggregated feature map, and the second aggregated feature map.

In some implementations, the predetermined input comprises a noise feature representation and constraint information for the target object, and wherein generating the target feature representation comprises: generating, using the diffusion model, the target feature representation from the noise feature representation under a condition of the constraint information.

In some implementations, the diffusion model comprises at least one residual block, and generating the target feature representation from the noise feature representation comprises inputting the constraint information into one or more of the at least one residual block.

In some implementations, the constraint information comprises at least one of the following: image feature information extracted from a reference image using a trained image encoder model, text feature information extracted from reference text using a trained text diffusion model, or noise information extracted from a random noise distribution using a trained random diffusion model.

In some implementations, the diffusion model comprises a first diffusion model and a second diffusion model, and wherein generating the target feature representation comprises: generating, using the first diffusion model, an intermediate feature representation from the predetermined input, the intermediate feature representation comprising a set of intermediate feature maps with a first resolution corresponding to the tri-plane, respectively; and generating, using the second diffusion model, the target feature representation from the intermediate feature representation, the target feature map in the target feature representation having a second resolution greater than the first resolution.

In some implementations, training of the second diffusion model comprises: obtaining a sample intermediate feature representation and a sample target feature representation generated from the sample three-dimensional avatar, the sample intermediate feature representation comprising a first set of sample feature maps with the first resolution corresponding to the tri-plane, respectively, and the sample target feature representation comprising a second set of sample feature maps with the second resolution corresponding to the tri-plane, respectively; generating, using the second diffusion model, a predicted feature representation from the sample intermediate feature representation; and updating the second diffusion model at least based on a first error between the predicted feature representation and the sample target feature representation.

In some implementations, the training of the second diffusion model further comprises: generating a predicted three-dimensional avatar of the sample object based on a rendering process for the predicted feature representation; and updating the second diffusion model further based on a second error between the predicted three-dimensional avatar and the sample three-dimensional avatar.

In some implementations, generating the three-dimensional avatar of the target object comprises: generating, using a trained decoding model, three-dimensional information of the target object from the target feature representation, the three-dimensional information indicating color information and density information of a plurality of points of the target object in a three-dimensional space; and generating the three-dimensional avatar of the target object through volumetric rendering of the three-dimensional information.

In another aspect, the subject matter described herein provides an electronic device. The electronic device comprises: a processor; and a memory coupled to the processor and comprising instructions stored thereon which, when executed by the processor, cause the device to perform acts comprising: obtaining a trained diffusion model, the diffusion model being trained based on a sample three-dimensional avatar of a sample object; generating, using the diffusion model, a target feature representation from a predetermined input, the target feature representation comprising a set of target feature maps corresponding to a tri-plane, respectively, to characterize feature information of a target object in a three-dimensional space; and generating a three-dimensional avatar of the target object based on the target feature representation.

In some implementations, the diffusion model comprises a plurality of convolutional layers. In some implementations, generating the target feature representation comprises: for a given convolutional layer of the plurality of convolutional layers, determining a given input for the given convolutional layer from the predetermined input, the given input comprising a first concatenated feature map determined by concatenating a set of feature maps corresponding to the tri-plane in a horizontal or vertical direction; performing convolution processing on the first concatenated feature map using the given convolutional layer, to obtain a second concatenated feature map; and generating the target feature representation based on the second concatenated feature map.

In some implementations, in the convolution processing, for a given feature point in a first feature map of the first concatenated feature map corresponding to a first plane of the tri-plane, a convolution operation for the given feature point is performed at least based on the given feature point, a first set of feature points in a second feature map corresponding to a second plane of the tri-plane, and a second set of feature points in a third feature map corresponding to a third plane of the tri-plane. The first set of feature points comprises a row of feature points on a first projection line of the second feature map for the given feature point, and the second set of feature points comprises a column of feature points on a projection line of the third feature map for the given feature point.

In some implementations, performing the convolution processing comprises: for the first feature map, row-wise aggregating a plurality of rows of feature points in the second feature map, to obtain a feature-point aggregated column; column-wise aggregating a plurality of columns of feature points in the third feature map, to obtain a feature-point aggregated row; and for each feature point in the first feature map, performing convolution processing based on the feature point, the feature-point aggregated column, and the feature-point aggregated row.

In some implementations, performing the convolution processing based on the feature point, the feature-point aggregated column, and the feature-point aggregated row comprises: column-wise replicating the feature-point aggregated column to obtain a first aggregated feature map with a same size as the second feature map; row-wise replicating the feature-point aggregated row to obtain a second aggregated feature map with a same size as the third feature map; and performing a two-dimensional convolution operation on a channel-wise concatenated map of the first feature map, the first aggregated feature map, and the second aggregated feature map.

In some implementations, the predetermined input comprises a noise feature representation and constraint information for the target object, and wherein generating the target feature representation comprises: generating, using the diffusion model, the target feature representation from the noise feature representation under a condition of the constraint information.

In some implementations, the diffusion model comprises at least one residual block, and generating the target feature representation from the noise feature representation comprises inputting the constraint information into one or more of the at least one residual block.

In some implementations, the constraint information comprises at least one of the following: image feature information extracted from a reference image using a trained image encoder model, text feature information extracted from reference text using a trained text diffusion model, or noise information extracted from a random noise distribution using a trained random diffusion model.

In some implementations, the diffusion model comprises a first diffusion model and a second diffusion model, and wherein generating the target feature representation comprises: generating, using the first diffusion model, an intermediate feature representation from the predetermined input, the intermediate feature representation comprising a set of intermediate feature maps with a first resolution corresponding to the tri-plane, respectively; and generating, using the second diffusion model, the target feature representation from the intermediate feature representation, the target feature map in the target feature representation having a second resolution greater than the first resolution.

In some implementations, training of the second diffusion model comprises: obtaining a sample intermediate feature representation and a sample target feature representation generated from the sample three-dimensional avatar, the sample intermediate feature representation comprising a first set of sample feature maps with the first resolution corresponding to the tri-plane, respectively, and the sample target feature representation comprising a second set of sample feature maps with the second resolution corresponding to the tri-plane, respectively; generating, using the second diffusion model, a predicted feature representation from the sample intermediate feature representation; and updating the second diffusion model at least based on a first error between the predicted feature representation and the sample target feature representation.

In some implementations, the training of the second diffusion model further comprises: generating a predicted three-dimensional avatar of the sample object based on a rendering process for the predicted feature representation; and updating the second diffusion model further based on a second error between the predicted three-dimensional avatar and the sample three-dimensional avatar.

In some implementations, generating the three-dimensional avatar of the target object comprises: generating, using a trained decoding model, three-dimensional information of the target object from the target feature representation, the three-dimensional information indicating color information and density information of a plurality of points of the target object in a three-dimensional space; and generating the three-dimensional avatar of the target object through volumetric rendering of the three-dimensional information.

In yet another aspect, the subject matter described herein provides a computer program product that is tangibly stored in a computer storage medium and comprises computer executable instructions that, when executed by a device, cause the device to perform acts comprising: obtaining a trained diffusion model, the diffusion model being trained based on a sample three-dimensional avatar of a sample object; generating, using the diffusion model, a target feature representation from a predetermined input, the target feature representation comprising a set of target feature maps corresponding to a tri-plane, respectively, to characterize feature information of a target object in a three-dimensional space; and generating a three-dimensional avatar of the target object based on the target feature representation.

In some implementations, the computer executable instructions that, when executed by a device, cause the device to perform one or more example implementations of the method in the above aspect.

In yet another aspect, the subject matter described herein provides a computer-readable medium having computer executable instructions stored thereon that, when executed by a device, cause the device to perform one or more example implementations of the method of the above aspect.

The functionalities described herein can be performed, at least in part, by one or more hardware logic components. As an example, and without limitation, illustrative types of hardware logic components that can be used include field-programmable gate arrays (FPGAs), Application-specific Integrated Circuits (ASICs), application-specific standard products (ASSPs), system-on-a-chip systems (SOCs), complex programmable logic devices (CPLDs), and the like.

Program code for carrying out the methods of the subject matter described herein may be written in any combination of one or more programming languages. The program code may be provided to a processor or controller of a general-purpose computer, special purpose computer, or other programmable data processing flowchart such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of the subject matter described herein, a machine-readable medium may be any tangible medium that may contain or store a program for use by or in connection with an instruction execution system, flowchart, or device. The machine-readable medium may be a machine-readable signal medium or a machine-readable storage medium. A machine-readable medium may include but is not limited to an electronic, magnetic, optical, electromagnetic, infrared, or semiconductor system, flowchart, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1-15. (canceled)

16. A computer-implemented method, comprising:
obtaining a trained diffusion model, the diffusion model being trained based on a sample three-dimensional avatar of a sample object;
generating, using the diffusion model, a target feature representation from a predetermined input, the target feature representation comprising a set of target feature maps corresponding to a tri-plane, respectively, to characterize feature information of a target object in a three-dimensional space; and
generating a three-dimensional avatar of the target object based on the target feature representation.

17. The method of claim 16, wherein the diffusion model comprises a plurality of convolutional layers, and generating the target feature representation comprises:
for a given convolutional layer of the plurality of convolutional layers, determining a given input for the given convolutional layer from the predetermined input, the given input comprising a first concatenated feature map determined by concatenating a set of feature maps corresponding to the tri-plane in a horizontal or vertical direction;
performing convolution processing on the first concatenated feature map using the given convolutional layer, to obtain a second concatenated feature map; and
generating the target feature representation based on the second concatenated feature map.

18. The method of claim 17, wherein in the convolution processing, for a given feature point in a first feature map of the first concatenated feature map corresponding to a first plane of the tri-plane, a convolution operation for the given feature point is performed at least based on the given feature point, a first set of feature points in a second feature map corresponding to a second plane of the tri-plane, and a second set of feature points in a third feature map corresponding to a third plane of the tri-plane, and
wherein the first set of feature points comprises a row of feature points on a first projection line of the second feature map for the given feature point, and the second set of feature points comprises a column of feature points on a projection line of the third feature map for the given feature point.

19. The method of claim 18, wherein performing the convolution processing comprises: for the first feature map,
row-wise aggregating a plurality of rows of feature points in the second feature map, to obtain a feature-point aggregated column;
column-wise aggregating a plurality of columns of feature points in the third feature map, to obtain a feature-point aggregated row; and
for each feature point in the first feature map, performing convolution processing based on the feature point, the feature-point aggregated column, and the feature-point aggregated row.

20. The method of claim 19, wherein performing the convolution processing based on the feature point, the feature-point aggregated column, and the feature-point aggregated row comprises:
column-wise replicating the feature-point aggregated column to obtain a first aggregated feature map with a same size as the second feature map;
row-wise replicating the feature-point aggregated row to obtain a second aggregated feature map with a same size as the third feature map; and
performing a two-dimensional convolution operation on a channel-wise concatenated map of the first feature map, the first aggregated feature map, and the second aggregated feature map.

21. The method of claim 16, wherein the predetermined input comprises a noise feature representation and constraint information for the target object, and wherein generating the target feature representation comprises:
generating, using the diffusion model, the target feature representation from the noise feature representation under a condition of the constraint information.

22. The method of claim 21, wherein the constraint information comprises at least one of the following:
image feature information extracted from a reference image using a trained image encoder model,
text feature information extracted from reference text using a trained text diffusion model, or
noise information extracted from a random noise distribution using a trained random diffusion model.

23. The method of claim 16, wherein the diffusion model comprises a first diffusion model and a second diffusion model, and wherein generating the target feature representation comprises:
generating, using the first diffusion model, an intermediate feature representation from the predetermined input, the intermediate feature representation comprising a set of intermediate feature maps with a first resolution corresponding to the tri-plane, respectively; and
generating, using the second diffusion model, the target feature representation from the intermediate feature representation, the target feature map in the target feature representation having a second resolution greater than the first resolution.

24. The method of claim 23, wherein training of the second diffusion model comprises:
obtaining a sample intermediate feature representation and a sample target feature representation generated from the sample three-dimensional avatar, the sample intermediate feature representation comprising a first set of sample feature maps with the first resolution corresponding to the tri-plane, respectively, and the sample target feature representation comprising a second set of sample feature maps with the second resolution corresponding to the tri-plane, respectively;
generating, using the second diffusion model, a predicted feature representation from the sample intermediate feature representation; and
updating the second diffusion model at least based on a first error between the predicted feature representation and the sample target feature representation.

25. The method of claim 24, wherein the training of the second diffusion model further comprises:
generating a predicted three-dimensional avatar of the sample object based on a rendering process for the predicted feature representation; and
updating the second diffusion model further based on a second error between the predicted three-dimensional avatar and the sample three-dimensional avatar.

26. The method of claim 16, wherein generating the three-dimensional avatar of the target object comprises:
generating, using a trained decoding model, three-dimensional information of the target object from the target feature representation, the three-dimensional information indicating color information and density information of a plurality of points of the target object in a three-dimensional space; and
generating the three-dimensional avatar of the target object through volumetric rendering of the three-dimensional information.

27. An electronic device comprising:
a processor; and
a memory coupled to the processor and comprising instructions stored thereon which, when executed by the processor, cause the device to perform acts comprising:
obtaining a trained diffusion model, the diffusion model being trained based on a sample three-dimensional avatar of a sample object;
generating, using the diffusion model, a target feature representation from a predetermined input, the target feature representation comprising a set of target feature maps corresponding to a tri-plane, respectively, to characterize feature information of a target object in a three-dimensional space; and
generating a three-dimensional avatar of the target object based on the target feature representation.

28. The device of claim 27, wherein the diffusion model comprises a plurality of convolutional layers, and generating the target feature representation comprises:
for a given convolutional layer of the plurality of convolutional layers, determining a given input for the given convolutional layer from the predetermined input, the given input comprising a first concatenated feature map determined by concatenating a set of feature maps corresponding to the tri-plane in a horizontal or vertical direction;
performing convolution processing on the first concatenated feature map using the given convolutional layer, to obtain a second concatenated feature map; and
generating the target feature representation based on the second concatenated feature map.

29. The device of claim 28, wherein in the convolution processing, for a given feature point in a first feature map of the first concatenated feature map corresponding to a first plane of the tri-plane, a convolution operation for the given feature point is performed at least based on the given feature point, a first set of feature points in a second feature map corresponding to a second plane of the tri-plane, and a second set of feature points in a third feature map corresponding to a third plane of the tri-plane, and
wherein the first set of feature points comprises a row of feature points on a first projection line of the second feature map for the given feature point, and the second set of feature points comprises a column of feature points on a projection line of the third feature map for the given feature point.

30. The device of claim 29, wherein performing the convolution processing comprises: for the first feature map,
row-wise aggregating a plurality of rows of feature points in the second feature map, to obtain a feature-point aggregated column;
column-wise aggregating a plurality of columns of feature points in the third feature map, to obtain a feature-point aggregated row; and
for each feature point in the first feature map, performing convolution processing based on the feature point, the feature-point aggregated column, and the feature-point aggregated row.

31. The device of claim 30, wherein performing the convolution processing based on the feature point, the feature-point aggregated column, and the feature-point aggregated row comprises:
column-wise replicating the feature-point aggregated column to obtain a first aggregated feature map with a same size as the second feature map;
row-wise replicating the feature-point aggregated row to obtain a second aggregated feature map with a same size as the third feature map; and
performing a two-dimensional convolution operation on a channel-wise concatenated map of the first feature map, the first aggregated feature map, and the second aggregated feature map.

32. The device of claim 28, wherein the predetermined input comprises a noise feature representation and constraint information for the target object, and wherein generating the target feature representation comprises:
generating, using the diffusion model, the target feature representation from the noise feature representation under a condition of the constraint information.

33. The device of claim 28, wherein the diffusion model comprises a first diffusion model and a second diffusion model, and wherein generating the target feature representation comprises:
generating, using the first diffusion model, an intermediate feature representation from the predetermined input, the intermediate feature representation comprising a set of intermediate feature maps with a first resolution corresponding to the tri-plane, respectively; and
generating, using the second diffusion model, the target feature representation from the intermediate feature representation, the target feature map in the target feature representation having a second resolution greater than the first resolution.

34. The device of claim 33, wherein training of the second diffusion model comprises:
obtaining a sample intermediate feature representation and a sample target feature representation generated from the sample three-dimensional avatar, the sample intermediate feature representation comprising a first set of sample feature maps with the first resolution corresponding to the tri-plane, respectively, and the sample target feature representation comprising a second set of sample feature maps with the second resolution corresponding to the tri-plane, respectively;
generating, using the second diffusion model, a predicted feature representation from the sample intermediate feature representation; and
updating the second diffusion model at least based on a first error between the predicted feature representation and the sample target feature representation.

35. A computer program product that is tangibly stored in a computer storage medium and comprises computer executable instructions which, when executed by a device, cause the device to perform acts comprising:
obtaining a trained diffusion model, the diffusion model being trained based on a sample three-dimensional avatar of a sample object;
generating, using the diffusion model, a target feature representation from a predetermined input, the target feature representation comprising a set of target feature maps corresponding to a tri-plane, respectively, to characterize feature information of a target object in a three-dimensional space; and
generating a three-dimensional avatar of the target object based on the target feature representation.
